(19) United States
(12) Patent Application Publication
(10) Pub. No.: US 2011/0260031 A1
(43) Pub. Date: Oct. 27, 2011

(54) MULTIFUNCTIONAL SUPPLY ELEMENT

(76) Inventor: Jiri Burda, Friedrichsdorf (DE)

(21) Appl. No.: 13/129,850

(22) PCT Filed: Nov. 20, 2009
(86) PCT No.: PCT/EP09/65591

§ 371 Date: Jul. 13, 2011

(30) Foreign Application Priority Data
Nov. 20, 2008 (DE) 202008013788.8
Sep. 15, 2009 (DE) 202009011006.0

(51) Int. Cl. F16M 13/00; F16M 11/00; A47G 29/00

(52) U.S. Cl. 248/558; 248/694; 248/324

(57) ABSTRACT

The invention relates to a multifunctional supply element with different functional elements for the emission of heat, light radiation or audio or video information. The known supply elements consist of radiant heaters and lighting elements, which are arranged in separate or a common housing.

In order to enhance its attractiveness and flexibility, the invention proposes that firstly other types of functional elements, such as water spraying elements, loudspeakers, display devices, are connected to the support of the supply element in a fixed or rotatable manner and secondly, that the individual functional elements are supplied via a universal bus system, so that any desired functionalities can be connected to the respective connections.

### TECHNICAL SUBJECT AREA

The invention relates to a multifunctional supply element, in particular for lighting, heating, air conditioning, sonic radiation and/or supplying information inside an enclosed room or an open air area.

In particular the invention also relates to a supply element with a heating element in the form of a radiant heater integrated in a housing or in a housing part and at least one other functional element in the form of a loudspeaker, a water emitting cooling element or of a lighting element. The invention additionally relates to a light and heat radiator with a support and at least one light-emitting lighting element arranged on the support, and with a radiant heat-emitting heating element.

### PRIOR ART

Combined supply elements of this type are known as illumination and heating elements from EP 1530404A. In the light and heat radiator described there a central housing is provided, which contains an infrared radiator emitter in the form of an elongated rod. On both sides of this housing, pivotable connected to the housing, a lamp housing is provided, which in each case comprises a halogen emitter. These combined light and heat radiators have the advantage that not only heat, but also light can be simultaneously connected to an installation, wherein such light and heat radiator combinations are preferably used in the restaurant trade, on domestic patios or on balconies.

Despite these advantages however, the known light and heat radiators have a certain disadvantage with regard to their mounting site or their flexibility. Thus firstly, a flat surface or a straight mounting edge must be available, along which the elongated light and heat radiator can be mounted. Secondly the attractiveness of the known light and heat radiators in comparison to the competitor, a simple model with a simple housing in which a heating element or a gas burner is arranged, is often not sufficiently high. Thus, the use of the known combined light and heat radiators can be problematic in some locations, for example in tents, under marquees or in round gazebos.

It is also often desirable if supply elements can be provided with functional elements, the effect of which not only extends to the side or downwards, but which can also rather be placed in a room, for example as a light or heat source, such that they radiate from the centre or radially outwards.

### DESCRIPTION OF THE INVENTION

The problem addressed by the invention therefore is to create a multifunctional supply element of the type previously described, which can be positioned as flexibly as possible in a room while comprising as many additional functions as possible, so that other purchasing incentives can be generated. A second object of the invention is to create a multifunctional supply element which, by the use of the different types of functional elements and their flexible arrangement on the supply element, has as wide as possible a range of functionality.

The first problem is solved according to the invention by a multifunctional illumination and heating element according to Claim 1. The further object is achieved by a supply element according to one of Claim 2 or 3, the dependent claims describe advantageous extensions providing further means of solving both problems.

The configuration of the multifunctional supply element designed as an illumination or heating element according to the invention means, for one, that the support can now be used for other types of functional elements as well as illumination or heating modules. A further development extension of the support of the supply element also allows the supply element to be hung in a room or on a wall or post. To this end the support is designed as a stand with pedestal or as a suspension means, for example in the form of a suspended traffic light, so that the supply element is constructed and usable in the manner of a standard lamp or hanging lamp.

In the simplest cases a supply element according to the invention consists of a module having two different functions. While the combination of light and heat radiators is already known in the prior art cited above, supply modules comprise one or more heating elements, which can be combined with cooling devices, in particular with spray elements for spraying cooling water vapour or misted water. Such a simple supply element can be provided inside a housing, which can be fixed onto a wall or a ceiling by means of a fixing device.

Combination with other functional modules, which are arranged together on a support is particularly preferred however. Thus all functional modules can be assembled together via a common mounting and optionally supplied via a common bus system. This combination of heating elements and cooling elements in one supply element is of particular interest for use under marquees, sun shades, tents or on patios, where the supply elements can be an arranged and fixed onto the respective supporting posts or a central mast.

Below, the advantages of the invention are described, in particular based on a supply element that is composed of different functional elements which are arranged on a common support that is designed such that the supply element is constructed in style of a hanging heating lamp. This combination represents only one example however, combinations with all other types of functional elements than those functional elements described here can also be used for constructing a multifunctional element, in particular based on the illumination or heating function or a cooling function, which can be assembled above the support to form a very wide range of basic formats.

In particular the radiant heater can be connected to the element already cited for spraying misted water, which provides cooling due to the evaporation enthalpy, and/or to a loudspeaker and/or an illumination element.

In a preferred configuration of the combined light and heat radiator, giving an impression of particularly high quality, the fixing means can be a stainless steel rod, or also a rod made from another type of material. The rod can be designed to be telescopic, so that the light and heat radiator can be adjusted in the vertical direction. This telescopic rod function can also be driven by an electric motor, so that even in large spaces, for example using remote radio control, a height adjustment can be carried out.

A simpler or more rustic looking configuration of the combined light and heat radiator on the other hand can also be suspended from standard pulling or holding means, for example a chain or a steel cable. The electricity supply cable for supplying electricity to the lighting element or the heating element with the required voltage preferably extends along the elongated fixing means, onto which the support is fixed.

Naturally, the fixing means can also be formed of multiple rods or pulling means, which for example hang down from the ceiling in a V shape or in the manner of an inverted tripod. The latter configuration preferably comes into consideration when either no ceiling is present or the ceiling is unsuitable for supporting the corresponding forces.

The support is preferably designed to be polygonal in shape, in which case it has three or more angled regions as “corners” in the sense of the this invention, wherein these corners can of course also be rounded. Other functional elements could then be arranged at these corners, wherein for example on at least some of the corners, functional elements in the form of lighting elements can be provided. These functional elements can also be hinge-connected to the support there, as at the other positions as well, such that they can rotate or pivot, so that the functionality can be further increased. As an alternative to the lighting elements, the water-spraying cooling elements can be provided at the corners.

In addition all functional elements can be extractable via telescopic supports, i.e. removed from the actual attachment point. Using easily detachable fixings and standardised connection systems, a rapid assembly and replaceability of the functional elements can be realised, even in the respective type of usage.

In a particularly attractive configuration of the combined light and heat radiator, lighting elements are arranged at all corners of the, for example, 3-cornered support, which can have a separate lamp housing. The lamp housing can be for example a halogen emitter or also multiple halogen emitters, wherein the emitters themselves or also the lamp housing itself can be designed to be rotatable or pivotable. The lighting strength can of course be designed to be adjustable using a suitable dimmer, if such a function is desired.

Along the edges of the support between two opposite corners, the heating element is then arranged. Here also all edges can be fitted with a heating element, or heating elements can also be arranged only at some points. Heating elements preferably comprise a housing, which has infrared radiation-emitting heating rods in its interior. These housings are generally known and usually designed as a reflector that supports the rods arranged in the reflector, the reflector itself being covered by a protective grid, which prevents touching of the heating rods by people or also by any material carried by the wind. These housings can be fixed either onto the support itself or also, if they are arranged between two lighting elements, on the lighting elements themselves, which are then in turn fixed onto the support.

The heating elements are preferably arranged on the support, or between the two lighting elements, such that they can rotate or pivot. In this manner the emission angle of the heating elements can be adjusted so that, for example, different angles can be set depending on the size of the room to be irradiated. The adjustability of the emission angle is particularly practical when in the case of the heating elements the quantity of heat can also be set via a power regulator, so that for example in small rooms with heating elements that radiate more strongly downwards, a low heating power is selected, while when using the same combined light and heat radiator in a relatively large room with more widely spread emission angles of the heat radiation, a higher power can be set.

The facility to adjust the emission angle both of the heat radiation as well as the light in combination with the ability to regulate the respective power levels makes the combined light and heat radiator universally applicable, so that it can be adapted to the respective usage sites.

Normally the supply element is suspended in a room, that is, it hangs down from the ceiling or the edges of the walls. Alternatively of course, the fixing means can be extended downwards, so that it can be supported on the floor. In this case the supply element essentially has the shape of a multifunctional heating mantle or a standard lamp, wherein here, as known in standard gas heating mantles, an additional cover element can protect the combined light and heat radiator against the effects of weathering, which can furthermore serve as a reflector for the heat radiated upwards.

In elaborate systems the adjustability of the functional elements, i.e. for example both the heating elements and the lighting elements, can be driven by electric motors. Here in particular a remote radio control, which can be used to adjust the emission angle of the light or the heat radiation, is particularly suitable, which recommended in particular in cases when the supply element is positioned at a height that prevents a manual adjustment or when there is a danger that, due to the heating up of the device, the emission angle can be changed without the risk of causing a fire.

The lighting elements can be ordinary lamps. All shapes of lamps can be used, both the halogen spotlights already cited above as well as classical energy saving lamps can be used. Also, the lighting elements can comprise any type of reflectors, in particular the reflectors can additionally also serve a protective function against heat radiation if the lighting elements are arranged very near to heating elements. This protective function can alternatively also be provided by the housing of the heating element, however.

As an alternative lighting element, an advertising vehicle can be used, which comprises a back-lit, optically transparent surface, on which for example advertising material can be displayed. Such advertising vehicles can be used in combination with ordinary lamps, so that the combined light and heat radiator can serve both an advertising function and a lighting function.

If the illumination of the room is provided by other methods then advertising elements alone can also be used, which facilitate, for example, a particularly effective placement of a brewery advertisement inside a restaurant facility. Thus the combined light and heat radiator receives an additional advertising function, which allows some users to finance the purchase of the device. At the same time, functioning is guaranteed during the time in which a heating facility is not required due to the outside warmth.

The combined light and heat radiator can comprise additional components to increase the functionality. In one particularly preferred configuration for example, in the area of the centre of the support a loudspeaker is arranged, over which either background music or announcements can be transmitted into the room. Also, the signal transmission for this loudspeaker is preferably carried out by means of a supply cable extending parallel to the fixing means of the support.

As an alternative to the loudspeaker, ventilators can also be used, which in the summer offer a ventilator function, while in the winter the heating elements warm up the room.

Any ventilators can additionally also be used to allow the rising warm air in the room to flow back down again, so that a continuous exchange can take place between the colder room air in the lower area of the room and the heated air in the upper part of the room. If the rotor blades of the ventilators cover the area of the heating elements, then of course by means of appropriate distance and/or appropriate materials it must be guaranteed that these are not damaged by the heat radiation.

Alternatively or in addition to the further functional elements cited above, the light and heat radiator can also comprise a water cooling device. in particular in regions in which high outside temperatures prevail, at high outside temperatures a cooling capability can be required. To this end a water spraying device can be provided, which like the loudspeaker can be provided in the central area of the support. Such a waster spraying device can then spray a water vapour mist or fine water droplets around, which evaporate in the warm outside air, so that the evaporation cooling in the room decreases and thus provides cooling in the room.

Finally with another configuration of the invention the support itself can be connected [by means of] a hinge to the fixing means. This hinge can firstly enable the support to be adjusted and fixed in its inclination, so that the light and heat radiator can be adapted to different angles of the fixing means, or that the emission angle of the overall system is adjustable. A further possibility is for the support, for example by means of an electric motor, to be set into rotation, so that in particular when the heat radiation is capable of covering the entire room around its circumference, it can be continuously distributed over the angular range.

A modular supply element, for example a modular system with different types of functional element, can be easily implemented with the system according to the invention: to this end, as the functional elements modules are used that are arranged parallel to or behind one another in a row and have, at least in part, different functions to one another. The functional modules can likewise be selected in particular from the following list of types (other functions can of course also be used):

Heating modules with at least one heat-emitting radiant heater,
illumination modules with at least one light emitting lighting element,
sonic radiation modules with at least one loudspeaker,
display modules with at least one back-lit information area or a display
Cooling modules for emitting water vapour or water vapour mist
input modules for inputting information microphone or camera modules for recording information or for room monitoring or
multifunctional modules with a combination of single or all of the functions of the other functional modules.

According to the modular structure of the supply element these functional modules thus formed are supplied for example via a central supply connection, via which starting from this supply connection the functional modules are supplied with the necessary inputs for their function via supply cables of a bus system.

This supply connection is preferably connected to an external module connection, for example to a building installation. The bus system has the necessary conduits for supplying and feeding all functional elements of the functional modules. It extends through or along the support, and can be connected to the functional elements via suitable interfaces.

In a preferred development of this modular supply element each output interface is designed so that it facilitates a connection to all supply lines of the supply cord, so that each type of functional module can be connected to each output interface. When no functional element is connected, that is the interface remains free, the interface can be designed so that supply lines, in particular water or steam conduits, are automatically shut off, as is known for example in the case of pressure lines. Electrical connectors can be automatically isolated by means of, for example, spring-loaded sleeves.

The connection of the functional elements to the supply terminal can be embodied as in German patent application 10 2008 055 585.1. The features from this patent application are therefore intended also to be applicable in connection with “small” module series on the support, on which multiple functional elements for forming these module series can be arranged one behind the other, and are via this reference expressly regarded as a component of the present invention. The supply bus, which in the patent application cited is referred to as a supply cord, supplies in a star pattern the functional elements that are arranged independently of each other on the support, or also the individual module series.

The use of the universal bus system to supply the functional elements via one connection type is particularly practical, since this facilitates the customised mounting of components on a support. Thus for example one and the same support can be used to use heating or cooling elements (water sprayers), so that the support is equally well applicable to winter devices as to summer devices.

The bus system and the connections thereto are embodied such that on connection of a functional element to the respective socket each plug opens the necessary conduits or makes the necessary connections. This can be effected via electrical plug connections or spring-loaded valves, which are known for example from the hydraulics or pneumatics fields.

The interfaces are assembled such that each functional element of a specific type can be docked onto it and in doing so, preferably only those conduits which are required for the function are connected. Of course it is also possible that the entire bus system is daisy-chained through the housing of the functional element, that is to say, at an outlet point of the housing a connection for another functional element is provided, to which regardless of the function of the functional element, every other type of functional element can be functionally connected.

Furthermore, the universal bus and connection system facilitates the modular structure, so that the customer can adapt the functionality of the supply element to his own personal or seasonal requirements as desired. This facilitates a building-block type of structure of the system, either to enhance the flexibility for the customer or for the manufacturer.

Further features and advantages of the invention result from the dependent claims and from the following description of preferred exemplary embodiments using the drawings.

### BRIEF DESCRIPTION OF THE DRAWINGS

The drawings show:

FIG. 1 an illustrative example of the supply element according to the invention, which is designed in the form of a hanging lamp,

FIG. 2 a further configuration of a supply element with wall or ceiling mounting,

FIG. 3 a functional element for use with the present invention, designed as a radiant heater,

FIG. 4 a further functional element for use with the present invention, designed as a lighting element in the form of a light strip,

FIG. 5 a third functional element for use with the present invention, which is designed as a device for displaying scrolling text,

FIG. 6 a fourth functional element for use with the present invention, which is constructed from a combination of a heating element and two external water spraying elements and

FIG. 7 a functional element constructed as a lighting element with connection to a bus system.

### BEST MEANS OF EMBODYING THE INVENTION

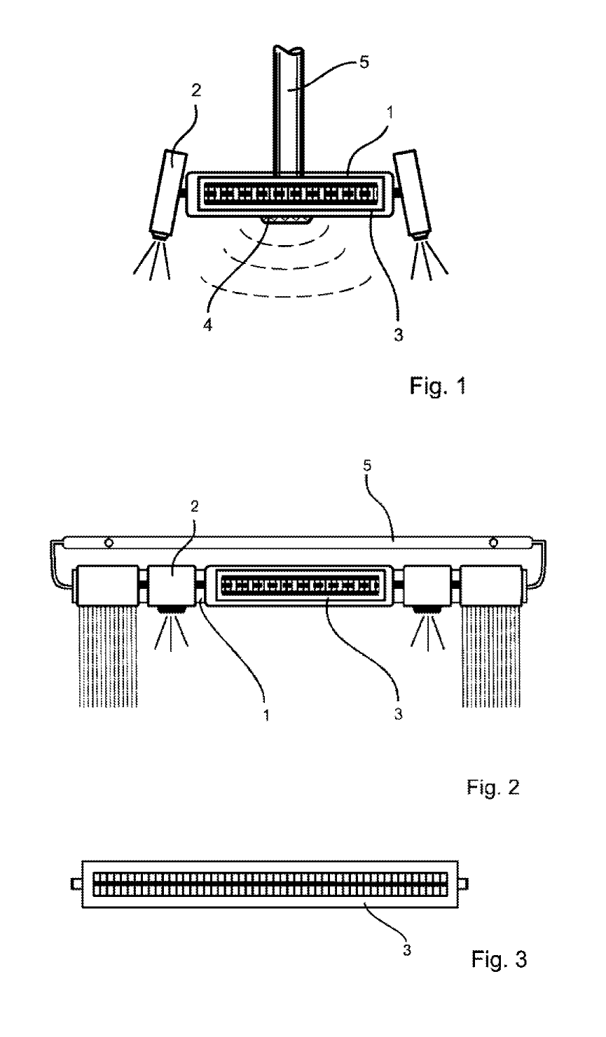

The combined light and heat radiator shown in FIG. 1 comprises a triangular support 1, which is arranged on a fixing means 5.

This fixing means 5 here is designed as a hollow cylindrical rod, which like the remaining parts of the light and heat radiator, is manufactured from stainless steel. The hollow cylindrical rod of the fixing means 5 accommodates the supply conduits for the additional components of the combined light and heat radiator, so that these are passed upwards where they cannot be seen. The fixing means 5 here is, for example, fixed to the ceiling of a room, wherein the support 1 is attached to the lower end of the fixing means 5. The support 1 has a triangular basic shape, here in the form of a plate. Instead of such a plate of course, a frame or any other form of support can also be used.

At each of its three corners the triangular support 1 has a lighting element 2, which is formed here by a lamp housing, which has a halogen spotlight, indicated here by circles radiating upwards and downwards at a certain angle to the vertical and to the horizontal. In this manner the combined light and heat radiator can illuminate both the ceiling and the floor area of the room.

By the use of halogen spotlights with correspondingly large emission angles, a largely uniform illumination of the room can be effected. However, by selecting the respective lighting means and also the lighting element 2, virtually any customer requirement can in fact be satisfied. The use of coloured lamps is also possible, in order to achieve additional visual effects as required.

If the light and heat radiator shown here is to be used in the open air in connection with a leisure event, it is also possible that, using appropriate functions, the function of a lighting console can be fulfilled by means of the lighting elements 2, or that other light effects can be facilitated, e.g. also a laser show or similar, in the case of electric motor-driven moveable lighting means. In addition the light and heat radiator can in this case also be fitted with a mist generator, which can provide the appropriate effects, for example in the case of a dancing event.

Between each of the lighting elements 2 on a combined light and heat radiator shown here, a heating element 3 is provided. This heating element 3 is connected via two mountings to the housings of the lighting element 2, wherein the mountings are connected on one side to the reflector housing of the heating element 3 and on the other side to the housing of the lighting elements 2. This facilitates a rotatable mounting of the heating elements 3 between the two lighting elements 2. The combined light and heat radiator thus constructed therefore comprises three lighting element and three heating elements, so that a particularly effective illumination of the room is possible here.

In the centre of the combined light and heat radiator in the exemplary embodiment shown, a loudspeaker 4 is arranged. This loudspeaker 4 is also supplied with the necessary signals via a supply cable, which is passed upwards through the fixing means 5. Instead of such a loudspeaker, other components, such as coloured lamps, cooling elements or mist generators can also be provided for generating the effects already mentioned above.

According to the invention the support is not restricted to the use of a triangular or angular element, and in principle all configurations of a support are conceivable, up to and including a round or oval disc. In addition the support can also be formed by the housings of the functional elements themselves, which are then arranged for example in a triangle or a circle and both connected to one another and at least partly equipped with fixing or retaining means. The basic shapes of all functional elements can of course also vary within the standard range.

FIG. 2 illustrates a further configuration of the invention, comprising functional elements which are here arranged next to one another in a row. From the outside inwards, these comprise on each side firstly a water spraying element, then an illumination element 2 and then in the centre, a central heating element 3. The functional elements here are also arranged on a common support 1, which in turn is retained by a fixing device 5 that can be fixed onto the wall or a frame of an umbrella or marquee.

Here, all functional elements are designed to be rotatable relative to one another and to the support 1, which for example can be implemented by mounting them on appropriately constructed support stands between the individual functional elements or by mounting them on a common support rod, at least partially forming the support 1.

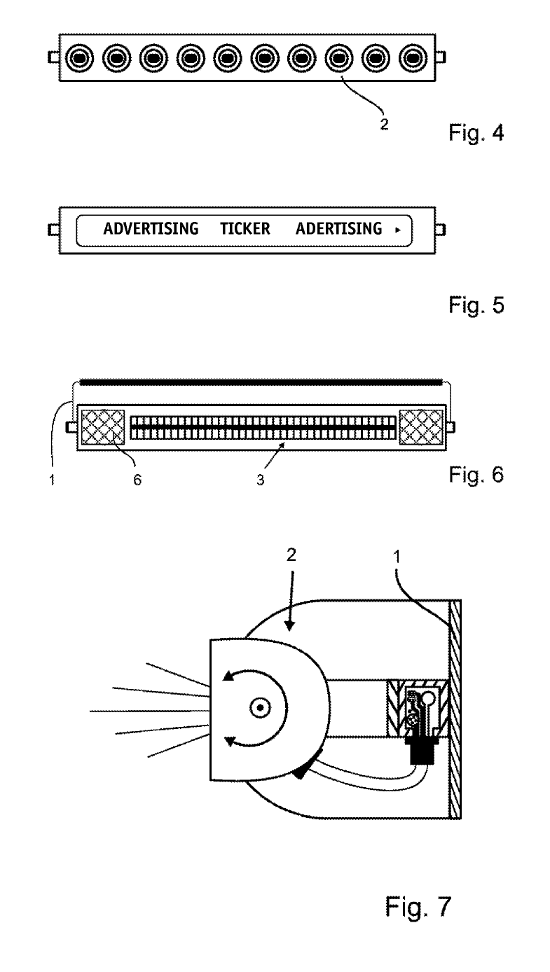

FIGS. 3 to 5 show examples of three possible functional elements. Here these are in FIG. 3 a heating element, in FIG. 2 a light strip as an illumination element and in FIG. 5 a display device for advertising and scrolling text.

FIG. 6 shows a simple and yet very attractive supply element, which can be used in isolation or also as a functional element in combination with the above described combinations, also via connection to the universal bus system. Here the support 1 is designed in the form of a bent holder for ceiling or wall mounting, wherein the housing is arranged on two bent legs, in which two water spraying elements 6 are arranged at the sides, with a heating element 3 between them in the centre.

It is precisely in the combination of the two individual functions that are opposite in their function where the specialised attractiveness of this functional element lies, since this generates a variety of possibilities for use. Such an element is thus justified for use almost the whole year round in all latitudes, since even in warm regions a heating effect can be desired in the evenings. Here, more correctly the advantage of the invention therefore conversely consists in the fact that the cooling device is extended by the heating function.

FIG. 7 finally shows a functional element in cross-section as a schematic illustration of the universal bus system. The support 1, on its side facing the housing of the functional element, has a bus channel in which all conduits that are required for the connection of the functional elements provided are guided.

The connection is designed so that using universal adapter plugs that can be plugged into mating sockets of the bus system, the required medium (pressurised water, steam, electricity supply, data, video or audio signals) can be tapped off.

### LIST OF REFERENCE LABELS

1 support
2 Lighting element
3 Heating element
4 Loudspeaker
5 Fixing means
6 Spray element for water or steam

1. A multifunctional supply element, in particular for illumination, heating, air conditioning, sonic radiation or supplying information, having a support constructed in the form of a retaining element, a stand or a wall-mounting device, wherein on the support are arranged: at least one lighting element or a heat-emitting heating element and at least one additional functional element, wherein at least one additional functional element is designed as a back-lit surface, as a spraying device for water vapour or finely misted water, as a lighting element or as a loudspeaker.

2. A multifunctional supply element, in particular for die illumination, heating, air conditioning, sonic radiation or supplying information, having a support constructed in the form of a retaining element, a stand or a wall-mounting device, wherein at least two functional elements are arranged on the support, that are constructed in the form of a lighting element or a heat-emitting heating element, a back-lit surface, a spraying device for water vapour or finely misted water, a lighting element or a loudspeaker, wherein the connection leads of the functional elements, in particular of the lighting element, the heating element and the loudspeaker are guided along the fixing means to a suspension point or fixing point or to the stand area of the lighting element, wherein the connection lines are combined in a common bus system which comprises all supply conduits and connections for the types of functional elements that are or can be used, wherein in order to create mutual interchangeability of the respective types of the functional elements, the functional elements and/or the heating elements can be connected to the bus system via uniform connections.

3. The multifunctional supply element according to claim 1, wherein the support is arranged at the lower end of a fixing means for the suspended fixing of the light and heat radiator, wherein the fixing means is arranged on a pedestal stand or on a ceiling or wall holder.

4. The multifunctional supply element according to claim 1, wherein the heating element and/or at least one of the additional functional elements are arranged fixedly or pivotably inside a common housing, which is connected to, or held by, the support fixedly or in a rotatable or pivotable manner.

5. The multifunctional supply element according to claim 1, wherein a further heating element and/or at least one of the additional functional elements is arranged inside a separate sub-housing, which is connected to the support in a rotatable or pivotable manner.

6. The multifunctional supply element according to claim 1, wherein the support has a polygonal form with three or more corners, wherein the heating elements are arranged fixedly or in a pivotable or rotatable manner between corners of the support and the additional functional elements are arranged fixedly or in a pivotable or rotatable manner on the corners of the support.

7. The multifunctional supply element according to claim 6, wherein a functional element, in particular a lighting element, is arranged on each corner of the support and the support comprises straight sections between the corners, wherein further functional elements are arranged along the straight sections and connected to the support in a fixed or rotatable manner or pivotably about a fixing point.

8. The multifunctional supply element according to claim 1, wherein the functional elements are fixed or hinge-connected to adjacent functional elements and/or heating elements.

9. The multifunctional supply element according to claim 1, wherein the rotatable or pivotable functional elements and/or the rotatable or pivotable heating elements are driven by electric motors and designed to be adjustable.

10. The multifunctional supply element according to claim 1, wherein the back-lit surface is an electronic display controllable via a computer or a television receiver, or formed by a lamp housing and at least one light source functioning as a background illumination, and a transparent surface arranged in front thereof for displaying advertising or other messages arranged thereon.

11. The multifunctional supply element according to claim 10, wherein the support is round, oval or polygonal and at least one functional element or one heating element is arranged in the centre of the support, either fixedly or via a fixing on a telescopic rod, such that it can be longitudinally displaced and/or rotated.

12. The multifunctional supply element according to claim 1, wherein the fixing means is formed by a hollow cylindrical rod, which is connected to the support at the lower end in a fixed or rotatable manner, and through the inner cavity of which the connection leads are guided.

13. The multifunctional supply element according to claim 1, wherein the fixing means is rotatably connected to the support and can be driven by electric motors to provide continuous rotation or to adjust the angle of rotation.
